(19) United States
(12) Patent Application Publication
(10) Pub. No.: US 2002/0105618 A1
(43) Pub. Date: Aug. 8, 2002

(54) Sprocket-hole banding filter and method of removing the sprocket-hole banding

(76) Inventors: Albert D. Edgar, Austin, TX (US); Richard D. Ball, Austin, TX (US)

Correspondence Address: LOCKE LIDDELL & SAPP LLP, 600 TRAVIS, 3400 CHASE TOWER, HOUSTON, TX, 77002-3095, US

(21) Appl. No.: 09/751,745

(22) Filed: Dec. 29, 2000

Related U.S. Application Data
(60) Provisional application No. 60/174,047, filed on Dec. 30, 1999.

(51) Int. Cl. G03B 19/18

(52) U.S. Cl. 352/38

(57) ABSTRACT

In general, the invention provides a method for filtering a repeating pattern in a medium comprising the steps of identifying a repeating pattern in the medium and subtracting out that pattern from the medium. The medium may be photographic film, magnetic recording tape, or any other medium capable of recording a signal. The repeating pattern has a known frequency, and may be a physical property of the medium such as a sprocket-hole banding artifact or a motion artifact. As such, there is disclosed a method of identifying and correcting undesirable artifacts associated with sprocket holes during digital film processing.

This application relies upon U.S. Provisional Application Serial No. 60/174,047 filed Dec. 30, 1999.

### FIELD OF THE INVENTION

This invention relates to digital film processing, and more specifically, to a method of identifying and correcting undesirable artifacts associated with sprocket holes during digital film processing.

### BACKGROUND OF THE INVENTION

In spite of the many advances in photography, the manner in which cameras take pictures has changed very little since the inception of photography. Light sensitive film is enclosed in a light-proof box. When a picture is taken, light is allowed to enter the box for a controlled length of time, and that light is focused through a lens onto a part of the light sensitive film, thereby “exposing” one picture. The film is then changed either by advancing the film from a storage spool or reel to a take-up spool or reel if the film is a continuous roll, or by removing the exposed film and replacing it with unexposed film if the film is “plate” type film.

The photographic film that is in the most widespread use today is 35-mm film, typically sold and distributed in cartridges containing a 35-mm filmstrip. In general, conventional film cartridges comprise a substantially hollow cylindrical magazine and a spool axially disposed in the center of the magazine. The filmstrip is wound about and attached at one end to the rotatable spool and has a free or leading end exposed through an elongated slit in the sidewall of the magazine.

The top and the bottom sides of the filmstrip are provided with a multiplicity of film-transport perforations or sprocket holes. To facilitate exposure of image frames in a camera, the free or leading end of the filmstrip is attached to a camera spool, and the filmstrip is unwound a frame at a time until all exposures are made. Then, the exposed filmstrip is rewound back onto the spool in the cartridge and provided to a photo-finisher to make prints or slides. These kinds of film rolls have been used for many years and are quite practical.

It is interesting to note that the sprocket holes that appear on 35-mm filmstrip trace their roots to the motion picture film industry, when motion picture film having sprocket holes were first introduced into still photography cameras by Leica in the 1920's. Because motion picture film was designed to be transported at very high speeds through clunky, mechanical, film projectors, it had very robust sprocket holes cut far into the film. These sprocket holes are not really needed in the still frame industry, but are there as a legacy standard.

In fact, with the development of modem technology, some manufacturers have recently developed a new kind of film roll that has only a few sprocket holes or no sprocket holes at all. For example, Advanced Photo System™ (APS) film has one small sprocket hole at regularly spaced intervals for marking each individual frame. In other words, the exposure position of each frame is predetermined, unlike the conventional film rolls in which the exposure position of each frame is determined by the length of the leader pulled out when mounting the roll into the camera and by the length of the film wound upon film advancing, hence the lack of efficient film planning. Some other films, such as 120 or 220 films used by professionals, have no sprocket holes at all. With 35 mm film, however, we are saddled with the legacy standard of robust sprocket holes.

During digital film processing, undesirable artifacts often appear on the film that are associated with the sprocket holes on the film. Because the sprocket holes are voids, 35 mm film is not completely flat and tends to warp a small amount around the sprocket holes. When a film processor places a developer solution on the surface, as in digital film processing, the developer tends to expand on one side more than on the other side, such that it bends differently around the sprocket holes.

Because of this, there is a pattern of waves across the developed film, that is correlated to the sprocket holes. These patterns or artifacts may appear as bright and dark waves and may behave differently in reflective or transmitted light.

Various methods have been used to reduce or minimize sprocket-hole banding, all of which take place during development of the film. First, it is beneficial to try to apply the developer on the film in a uniform fashion. Second, it is helpful to keep the developer from touching the sprocket holes themselves (perhaps through mechanical barriers) so that adjacency effects are minimized. Third, holding the film flatter during the development stages can reduce banding. And fourth, attempts should be made to develop the illumination over wider angles so that variations in the angles of the film affect the reflected light less. After all these efforts are made, however, sprocket-hole banding continues to exist in the final image.

Accordingly, to improve the quality of the final digital images that are produced, there is a need to identify and correct or remove these sprocket-hole artifacts that are captured on film.

### SUMMARY OF THE INVENTION

The present invention provides a method for filtering a repeating pattern in a medium comprising the steps of identifying a repeating pattern in the medium and removing that pattern from the medium. The medium may be photographic film, magnetic recording tape, or any other medium capable of recording a signal. The repeating pattern has a known frequency, and may be a physical property of the medium such as a sprocket-hole banding artifact or a motion artifact. In a particular embodiment, the present invention relates to digital film processing, and more specifically, to a method of identifying and correcting undesirable artifacts associated with sprocket holes during digital film processing.

The foregoing has outlined rather broadly the features of the apparatus and method of the present invention so that the detailed description of the invention that follows may be better understood. Additional features and advantages of the invention will be described hereinafter which form the subject of the claims of the invention.

It should be appreciated by those skilled in the art that the conception and the specific embodiments disclosed might be readily used as a basis for modifying or designing other structures or methods for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The accompanying drawings, which are incorporated in and form part of the specification, illustrate the embodiments of the present invention, and, together with the description, serve to explain the principles of the invention. In the drawings:

FIG. 1 is a flow chart describing the steps for generating a sprocket hole banding filter;

FIG. 2 is a software code developed to execute the steps of FIG. 1;

FIG. 3 is a flow chart describing the steps for applying a sprocket hole banding filter; and

FIG. 4 is a software code developed to execute the steps of FIG. 3.

It is to be noted that the drawings illustrate only typical embodiments of the invention and are therefore not to be considered limiting of its scope, for the invention will admit to other equally effective embodiments.

### DETAILED DESCRIPTION OF THE INVENTION

Digital imaging systems enable us to capture and store film images electronically, then process them on a computer, much like we process text and drawings. Of course, the most common ways to capture or make digital pictures are (1) scanning existing pictures from film negatives, slides, or prints, or (2) using a digital camera to take digital pictures. A film image is represented electronically by continuous analog wave forms. In contrast, a digital image is represented by digital values derived from sampling the analog image. These digital values are discrete electronic pulses that have been translated into strings of zeros and ones, the only digits in a binary numbering system.

Conventional electronic scanning of developed photographic negative film to produce digital images is done by passing visible light through the developed negative and using filters with appropriate spectral responsivities to detect, at each location on the film, the densities of cyan, magenta, yellow, and black dyes in the photographic negative. The density values detected in this way are indirect measures of the red, green, and blue light that initially exposed each location on the film.

These measured density values constitute three values used as the red, green, and blue values for each corresponding location, or pixel, in the digital image. Further processing of these pixel values is often performed to produce a digital image that accurately reproduces the original scene and that is pleasing to the human eye.

This invention relates to digital film processing, and more specifically, to a method of identifying and removing undesirable artifacts associated with sprocket holes during digital film processing. This invention is also useful in conventional scanning technology when sprocket holes are insufficiently masked, such as on a drum scanner.

The photographic film that is in the most widespread use today is 35-mm film (system 135) as provided for by Japanese Industrial Standards (JIS) and International Organization of Standardization (IOS). Ignoring dimensional tolerances, present 35-mm films for use in general photography have a width of 35 millimeters between opposite longitudinal edges and include a series of film-transport perforations or sprocket holes defined along the opposite longitudinal edges of the film.

As discussed previously, 35-mm film has the same sprocket holes that are found in motion picture films, because that was its origins. Each of the image areas or frames on 35-mm film is of a rectangular shape having a width of 24 mm across the film and a length of 36 mm along the film. As such, 11 mm of the 35 mm width is occupied by the sprocket holes region, sixteen sprocket holes per frame (eight above and eight below each frame).

While not being entirely understood, these sprocket holes create image defects during film development. For example, the defect may occur because of the developer flaring through the sprocket hole. This may result in less developer depletion in the area around the sprocket holes. The image defects may also occur because of mechanical variations or irregularities on the film caused by punching or die cutting the sprocket holes into the film. Any time there is a die cutting process, the film is going to deform at least slightly. Moreover, stress effects internal to the film may also cause sprocket-hole banding defects. Because there are sprocket holes in the film, as you stretch the film in various directions as it is going through the processing system, it is going to deform in different ways around the sprocket holes.

Because the sprocket holes have a uniform size and frequency, the sprocket-hole bands repeat in a fairly regular pattern down the length of the film. The bands are not exact duplicates throughout the film, but vary slightly in a variety of ways. For example, the variation can be caused by internal stresses in the film as it is being stretched through the exposure and development systems.

Likewise, any time the film moves a small amount in the system or the tension changes on it slightly just due to mechanical variations, that kind of effect is going to change the bands a little bit. Furthermore, the variations in the bands can be explained as being density sensitive. For example, a very dark area of the image is going to have a different sprocket-hole banding characteristic than a very light image.

After development of the 35-mm film, the image is fraught with sprocket-hole banding that serves as an undesirable artifact that can be identified and eliminated using the method and techniques of the present invention. In general, the sprocket-hole bands tend to look like a half moon shape that typically goes only a small distance away from the sprocket holes. These sprocket-hole bands are undesirable and should be removed or at least minimized in the final image. The trick, therefore, is to distinguish between what are the undesirable defect artifact and the actual image.

In a broad sense, the invention comprises the steps of identifying a repeating pattern in a medium and then removing that pattern from the medium. In this embodiment, the medium may be a photographic film, a magnetic recording tape, or any other medium capable of recording a signal. Likewise, the repeating pattern may be a physical property of the medium, such as a sprocket-hole banding artifact or a motion artifact. Put differently, the present invention is not restricted solely to sprocket-hole banding, but is useful as a banding filter for any repetitive banding present on a given medium.

More specifically, the invention comprises the steps of first, identifying the sprocket holes, second, identifying the sprocket-hole banding pattern that repeats in synchronization with the sprocket holes, and third, removing that pattern from the image. Of course, with respect to the second step, the pattern can change spatially and with density. For example, the pattern may vary with position because the film “walks” during processing, that is, it moves or wobbles back and forth. And with respect to the third step, removing the pattern from the image is not restricted to solely a numerical subtraction—it also includes methods of partially or fully reducing or eliminating the pattern.

In digital film processing, the image is captured with a solid state image sensor called a charge coupled device, or CCD for short. In general, the CCD is used to read and digitize the source image or film that passes under the CCD sensors. In one embodiment, the sensor is stationary and the film moves, or scans, across the scanner. In another embodiment, the film is stationary and the sensor scans across the film. More specifically, an area array CCD (that captures the image on a matrix basis) has thousands of photocells or sensors that generate several column arrays of elements called pixels by sensing the light intensity of small portions of the film image.

Film scanners often use three linear array image sensors covered with red, green, and blue filters. Each linear image sensor, containing thousands of photocells, is moved across the film to capture the image one-line-at-a-time. The brightness or color value of each pixel is defined by one bit or by a group of bits. The more bits that are included, the higher the brightness resolution.

Depending upon the desires of the operator, a variety of image processing techniques can be used to remove scratches or surface defects, enhance the colors, and fix the grain, among other error correction techniques or enhancement techniques available. The present invention is directed to removing sprocket hole artifacts formed by sprocket-hole banding. As another step in digital film processing, the pixels from the different views generated from the different imaging systems must be aligned to correct offsets and magnification errors.

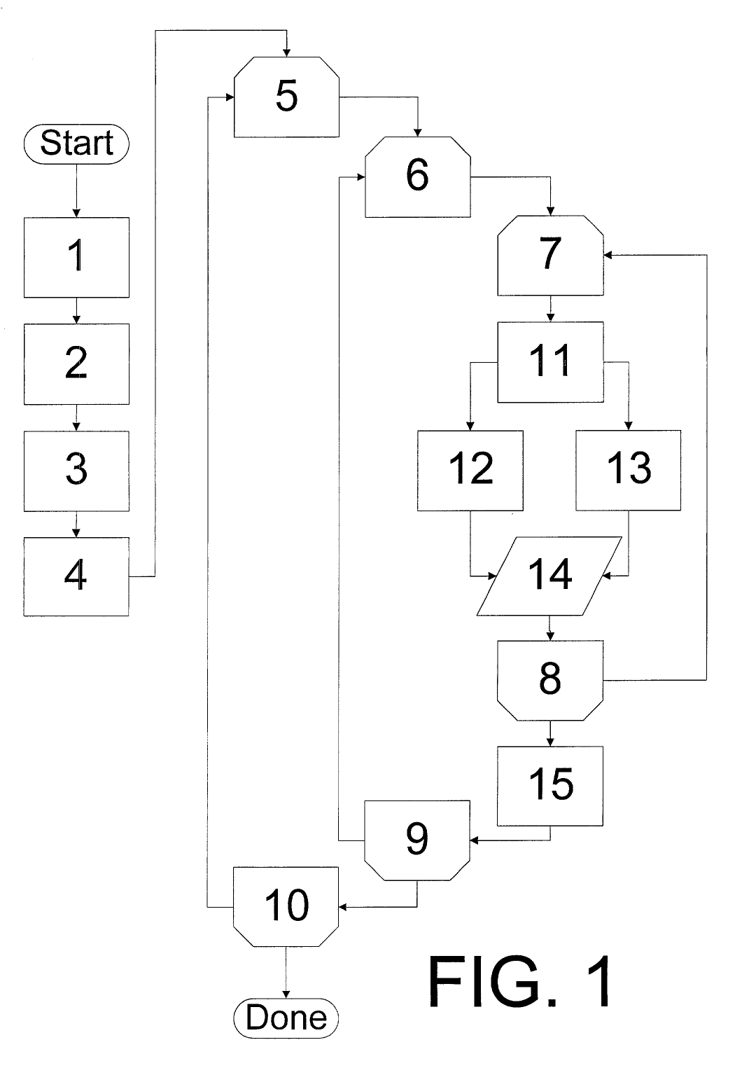

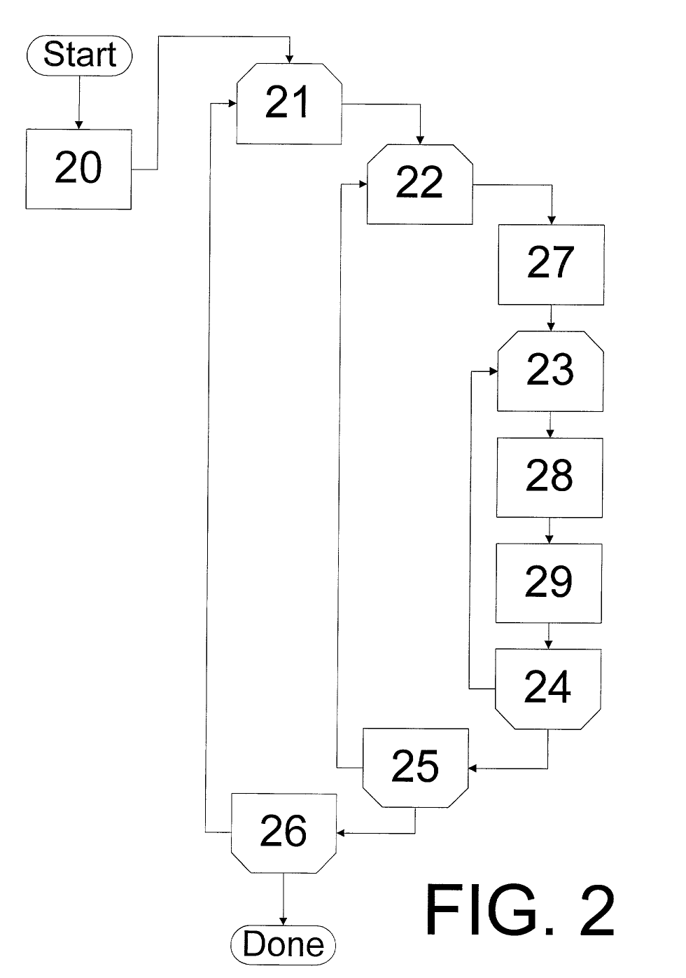

FIG. 1 provides a flow chart showing how the sprocket hole banding filter is generated. FIG. 2 is a software code developed to execute the steps of FIG. 1.

To identify and correct sprocket hole artifacts during digital film processing, the present invention's algorithms carry out the following processes on the data scanned from the developing film. First, as shown in Step A of FIG. 1, the algorithm provides a “gain” function as input to the routine—this function has a value for each possible code value in the original normalized image (i.e., 0-65535. This allows the filter to be optimized for effects that are determined to be code-value dependent (i.e., different in lighter vs. darker areas of the image).

Consider a histogram of a fairly well distributed image after the normalization process, with the x-axis representing the pixel value (how dark or light the image is) and the y-axis representing the number of pixels. An image with good contrast and good dynamic range generates a histogram with a pixel distribution across the brightness range from 0 to 255. Conversely, an image with low contrast has pixels distributed over a narrow dynamic range while an image with high contrast generates a histogram with a high pixel count at the white and black extremes of the range.

Second, the centerline axis of the sprocket holes are identified and located on the film. That is, the algorithms load the sprocket hole regions (top and bottom) of the normalized file (the rows containing sprocket holes are an input in this process), and filter the areas to locate the horizontal center of each hole. After that, they average the corresponding values from each list (top and bottom) to get a good estimate of the exact location of the center of each sprocket hole band. They also write the sprocket holes directly to the output files, since this data does not need to be filtered. In general, the location of the sprocket holes is found by analyzing the wave form attained by comparing the pixel code values across the sprocket hole region of the film.

Now, the location of the sprocket holes can be used to identify the sprocket-hole banding pattern that represents the undesirable artifact data that repeats at the sprocket hole frequency. Turning now to Step B of FIG. 1, the algorithms divide the film into horizontal sections, each “n” (usually 32) pixels high. The outermost loop of the algorithm will read each section, reducing it in both dimensions using a median filter (“n” pixels vertically, and “m” (usually 32) horizontally) to create a “thumbnail,” a one-dimensional array with a value for each (reduced resolution) x point along the long dimension of the film.

In Step C of FIG. 1, the thumbnail is processed by applying a boxcar filter with a width approximately equal to the sprocket hole period, the distance between the centers of two sprocket holes, nominally (395/32=13 pixels). The image is saved as “low pass,” and is then removed from the original image to produce “high pass.” (See Step D) Next, each high pass value is divided by the gain value for the corresponding thumbnail pixel code value. (See Step E) A “weight” is then calculated as the gain divided by the RMS deviation of the adjusted highpass image in an area equal to the surrounding sprocket hole period. (See Step F)

Next, a loop over each sprocket hole location is executed to build the sprocket-hole banding filter or template. Specifically, an offset from the hole center is selected, and then the code value from the high pass image at this offset in each sprocket hole “band” is saved, along with the corresponding weight, in an array. The weighted median of these arrays is the “correction factor” at the selected offset in the sprocket-hole band. (See Step G) This “weighted median” is calculated by first sorting the code values array along with the corresponding weights, then calculating the sum of the weights, and then selecting the element where the sum of the weights above and below are ½ the total sum.

FIG. 3 provides a flow chart showing how the sprocket hole banding filter is applied. FIG. 4 is a software code developed to execute the steps of FIG. 3. In general, the filter template is applied to the full-resolution image in sections equal to the filter width (one sprocket hole period). Since the left and right edges of the template will probably not have the same correction value, the interpolated filter is generated by “wrapping” from the final point to the initial point. Because the interpolated template value at each point in the band is the correction factor, it is simply removed from the original code value to get the final, “filtered” code value. These filtered code values are the corrections for the undesirable artifacts associated with sprocket holes. Of course, the template value need not be numerically subtracted from the banding value, but may undergo some other arithmetic operation (such as division) to reduce or eliminate the sprocket-hole banding artifact.

Moreover, in order to make the error correction more accurate, the algorithm recognizes that there could be different kinds of correlation of the actual artifact data with the filter that is generated. That is, in a particular sprocket hole band, the affect may be more or less pronounced.

When generating the template filter, the method of the present invention generated an average filter for the entire film roll, when in fact there is not necessarily that level of artifact in each one of the sprocket hole bands. Accordingly, the algorithm calculates a cross correlation function between the sprocket hole template and the actual image data and is compared with an autocorrelation of the image data with itself.

This enables the program to determine how much of the image data really matches with the filter template and how much of it does not match, and that provides a measure of how much artifact there is in a particular sprocket hole band. Specifically, the cross correlation of the template with the image divided by the autocorrelation of the image with itself gives the local gain. (See Step A of FIG. 3) Depending upon the local gain, the program can apply as little as half the correction or as much as one and a half the correction that is the average across the entire roll.

In sum, the present invention's algorithms generate corrective templates to correct for each undesirable artifact. These templates span one sprocket-hole band, a vertical band of the same width as the artifact, corresponding to the width between the centers of two sprocket holes. In one embodiment, these templates are created individually for each specific roll of film from the data scanned from that roll. In another embodiment, one application of these templates is derived for application to any roll of film. As such, a “standard” error correction template filter could be prepared that is specific to a film from a particular manufacturer.

While the present invention contemplates viewing the whole role of film in identifying the sprocket holes, in identifying the sprocket-hole banding, and in generating the template, it is to be appreciated by those skilled in the art that some number of frames less than the entire roll of film is probably sufficient to differentiate between the actual image data and the data that repeats at the sprocket hole frequency and is therefore artifact data.

Although the present invention and its advantages have been described in considerable detail, it should be understood that various changes, substitutions, and alterations could be made herein without departing from the spirit and scope of the invention as defined by the appended claims.

What is claimed is:

1. A method for removing the effects of sprocket hole banding in a scan of film having a plurality of sprocket holes, the method comprising the steps of:
identifying the position of the sprocket holes;
identifying a pattern that repeats in synchronization with the sprocket holes; and
removing the pattern from the film.

2. The method of claim 1 wherein the pattern changes spatially.

3. The method of claim 1 wherein the pattern changes with density.

4. A method of removing a repeating pattern in a medium comprising the steps of:
identifying the pattern that repeats in the medium;
correlating the pattern to a property of the medium; and
removing that pattern from the medium.

5. The method of claim 4 wherein the medium comprises photographic film.

6. The method of claim 4 wherein the medium comprises magnetic recording tape.

7. The method of claim 4 wherein the repeating pattern has a known frequency.

8. The method of claim 4 wherein the property is a physical property of the medium.

9. The method of claim 4 wherein the repeating pattern is a sprocket-hole banding artifact.

10. The method of claim 4 wherein the repeating pattern is a motion artifact.

11. A sprocket-hole banding filter for film having a plurality of sprocket holes comprising:
a scanner;
a processor connected to the scanner capable of identifying a plurality sprocket holes, finding a pattern that repeats in synchronization with the sprocket holes, and removing the pattern from the film.

12. The filter of claim 11 wherein the scanner comprises a charge coupled device.

13. The filter of claim 11 wherein the processor is capable of interpolation.

14. The filter of claim 11 wherein the processor is running a program comprising the algorithm in FIG. 4.

15. The filter of claim 11 wherein sprocket-hole banding occurs with respect to each sprocket hole.

16. The filter of claim 1 where the processor is capable of subtracting the sprocket hole pattern.

17. The method of claim 1 using an algorithm disclosed in FIGS. 1 and 3.

18. The method of claim 4 using an algorithm disclosed in FIGS. 1 and 3.
